(19) United States
(12) Patent Application Publication
(10) Pub. No.: US 2022/0395777 A1
(43) Pub. Date: Dec. 15, 2022

(54) Methane Oxidation Catalyst and Method of Using Same

(71) Applicant: Her Majesty the Queen in Right of Canada as Represented by the Minister of Natural Resources, Ottawa (CA)

(72) Inventors: Gianni Caravaggio, Ottawa (CA); Lioudmila Nossova, Ottawa (CA)

(21) Appl. No.: 17/764,588

(22) PCT Filed: Oct. 1, 2020
(86) PCT No.: PCT/CA2020/051312

§ 371 Date: Mar. 29, 2022

Related U.S. Application Data
(60) Provisional application No. 62/909,824, filed on Oct. 3, 2019.

(51) Int. Cl. B01D 53/86; B01D 53/94; B01J 23/44; B01J 23/10; B01J 35/10

(52) U.S. Cl. CPC B01D 53/864; B01D 53/944; B01J 23/44; B01J 23/10; B01J 35/1019; B01D 2255/1021; B01D 2255/1023

(57) ABSTRACT

Disclosed is a methane oxidation catalyst, and methods of use, the catalyst having a support comprising alumina doped with lanthanum and comprising platinum and palladium as the principle active phases. The platinum and palladium are present in the catalyst in a weight ratio of between 0.20:1.0 and 0.75:1.0, at an amount effective 5 for producing a product gas having reduced levels of methane as compared to a source gas prior to catalysis. Selected catalysts disclosed herein exhibit a capacity for sulfur and water resistance.

### BACKGROUND

This application claims the convention priority right of U.S. patent application 62/909,824 filed Oct. 3, 2019.

### TECHNICAL FIELD

The present disclosure relates to the field of methane oxidation catalysts for reducing unburned methane in a gas or gas stream comprising methane, and methods that employ such catalysts. Such gases and gas streams include those resulting from methane combustion, as well as methane release, including but not limited to natural gas engines, natural gas power plants, release of methane from mining operations, landfills, sewage and agricultural sources.

Natural gas largely comprises methane, which is a potent greenhouse gas (GHG). Unfortunately, unwanted natural gas release into the atmosphere occurs in many industrial, mining, and agricultural processes, as well as from sewage systems including sewage lines and septic systems.

Natural gas has also received increased interest as a fuel for the transportation and power production sectors since it is abundant and inexpensive. Lean burn natural gas engines are similar in performance to diesel engines and can be used in a wide variety of transportation applications such as light and medium duty vehicles, vocational and long-haul trucks and ships, as well as natural gas power plants. Natural gas engines offer a cleaner alternative than diesel and gasoline engines in that they produce approximately 20 to 25% less greenhouse gases (GHG) on a life-cycle basis due to the lower carbon content of methane. However, natural gas engines suffer from high levels of unburned methane in the exhaust. Because methane is a potent GHG (21 times GHG impact compared to CO₂), unburned methane in natural gas vehicle exhaust can negate its GHG benefit. While under certain conditions it is possible to calibrate the engine combustion to meet a methane emissions target, this can come at the expense of adversely impacting engine efficiency and other regulated emissions (e.g. NOₓ).

The use of catalysts is generally known to help to reduce or eliminate methane from sources of potential release of methane into the atmosphere, including but not limited to unburned methane resulting from combustion processes. However, there is a continuing need to develop improved catalysts for methane oxidation regardless of the source of methane. Selected methane oxidation catalysis exhibit disadvantages because they can be deactivated in the presence of one or more of carbon monoxide, sulfur and water, which may be components of natural gas engine exhaust or other natural gas sources. Furthermore, known catalysts are often not resistant to thermal and/or hydrothermal aging.

### SUMMARY

The present disclosure relates to a methane oxidation catalyst, and methods of using same.

Embodiment 1 provides a method for reducing methane in a source gas comprising methane and sulfur, the method comprising contacting the source gas with a methane oxidation catalyst having a support comprising alumina doped with lanthanum and comprising platinum and palladium as active phases, thereby producing a product gas comprising reduced levels of methane compared to the source gas, wherein the platinum and palladium are present in the methane oxidation catalyst at a weight ratio of Pt:Pd that is between 0.2:1.0 and 0.75:1.0.

Embodiment 2 provides the method of embodiment 1, wherein the methane oxidation catalyst consists of platinum and palladium as active phases, optionally together with less than 1% by weight of active phase impurities.

Embodiment 3 provides the method of embodiment 1 or 2, wherein the lower limit of the weight ratio of Pt:Pd is selected from 0.2001:1.0, 0.201:1.0, 0.21:1.0, 0.3:1.0, 0.4:1.0, 0.5:1.0, 0.6:1.0 and 0.7:1.0.

Embodiment 4 provides the method of embodiment 1, 2, or 3, wherein the upper limit of the weight ratio of Pt:Pd is selected from 0.3:1.0, 0.4:1.0, 0.5:1.0, 0.6:1.0, 0.7:1.0, 0.74:1.0, 0.749:1.0, and 0.7499:1.0.

Embodiment 5 provides the method of embodiment 1, wherein the source gas results from methane combustion and has a temperature of between 350° C. and 600° C.

Embodiment 6 provides the method of embodiment 1, wherein the source gas is heated to a temperature of between 350° C. and 600° C. prior to or upon contact with the methane oxidation catalyst.

Embodiment 7 provides the method of embodiment 1, wherein the platinum and/or palladium are each present in the methane oxidation catalyst at between 0.5 and 20 wt %.

Embodiment 8 provides the method of embodiment 1, wherein the platinum and palladium are present in the methane oxidation catalyst at a concentration effective to reduce the methane content in the source gas by at least 75% at 500° C. after 500 hours on stream.

Embodiment 9 provides the method of embodiment 1, wherein the methane oxidation catalyst has a T₅₀ of below 500° C. after aging in a simulated gas exhaust, such as a simulated natural gas vehicle exhaust, for 500 h at 500° C. in the presence of 10 vol % water and 10 ppm sulfur dioxide.

Embodiment 10 provides the method of embodiment 1, wherein the methane oxidation catalyst is prepared by incipient wetness impregnation in which the platinum and palladium are added sequentially and in which platinum is added before palladium, or wherein the methane oxidation catalyst is prepared by wet impregnation in which the platinum and palladium are added simultaneously.

Embodiment 11 provides the method of embodiment 1, wherein the alumina is gamma alumina.

Embodiment 12 provides the method of embodiment 1, wherein the specific surface area (BET) of the support is at least 120 m²/g.

Embodiment 13 provides the method of embodiment 1, wherein the source gas is derived from a natural gas engine, a natural gas power plant, an industrial process, a mining process, an underground source, a sewage source, an agricultural source, or a store of methane-producing material.

Embodiment 14 provides a methane oxidation catalyst comprising a support comprising alumina doped with lanthanum, and comprising platinum and palladium as active phases, wherein the platinum and palladium are present in the methane oxidation catalyst at a weight ratio of Pt:Pd that is between 0.2:1.0 and 0.75:1.0.

Embodiment 15 provides the catalyst of embodiment 14, wherein the methane oxidation catalyst consists of platinum and palladium as active phases, optionally together with less than 1% by weight of active phase impurities.

Embodiment 16 provides the catalyst of embodiment 14 or 15, wherein the lower limit of the weight ratio of Pt:Pd is selected from 0.2001:1.0, 0.201:1.0, 0.21:1.0, 0.3:1.0, 0.4:1.0, 0.5:1.0, 0.6:1.0 and 0.7:1.0.

Embodiment 17 provides the catalyst of embodiment 14, 15 or 16, wherein the upper limit of the weight ratio of Pt:Pd is selected from 0.3:1.0, 0.4:1.0, 0.5:1.0, 0.6:1.0, 0.7:1.0, 0.74:1.0, 0.749:1.0 and 0.7499:1.0.

Embodiment 18 provides the catalyst of embodiment 14 which exhibits catalytic activity upon methane in a source gas at, or heated to, a temperature of between 350° C. and 600° C.

Embodiment 19 provides the catalyst of embodiment 14, wherein the platinum and or palladium are each present in the methane oxidation catalyst at between 0.5 and 20 wt %.

Embodiment 20 provides the catalyst of embodiment 19, wherein the platinum is present in the methane oxidation catalyst at between 3 and 5 wt % and the palladium is present in the methane oxidation catalyst at between 1 and 3 wt %.

Embodiment 21 provides the catalyst of embodiment 14, wherein the catalyst has a T₅₀ of below 500° C. after aging in a simulated natural gas vehicle (NGV) exhaust for 500 h at 500° C. in the presence of 10 vol % water and 10 ppm sulfur dioxide.

Embodiment 22 provides the catalyst of embodiment 14, prepared by incipient wetness impregnation in which the platinum and palladium are added sequentially and in which platinum is added before palladium, or wherein the methane oxidation catalyst is prepared by wet impregnation in which the platinum and palladium are added simultaneously.

Embodiment 23 provides the catalyst of embodiment 14, wherein the alumina is gamma alumina.

Embodiment 24 provides the catalyst of embodiment 14, wherein the specific surface area (BET) of the support is at least 120 m²/g.

Embodiment 25 provides the method of any one of embodiments 14 to 24, for use to reduce a methane content of a source gas.

Embodiment 26 provides the catalyst for use of embodiment 25, wherein the source gas is derived from a natural gas engine, a natural gas power plant, an industrial process, a mining process, an underground source, a sewage source, an agricultural source, or a storage of methane-producing material.

Embodiment 27 provides for a use of the methane oxidation catalyst of any one of embodiments 14 to 24, to reduce methane content of a source gas.

Embodiment 28 provides the use of embodiment 27, wherein the source gas is derived from a natural gas engine, a natural gas power plant, an industrial process, a mining process, an underground source, a sewage source, an agricultural source, or a storage of methane-producing material.

According to another exemplary embodiment, there is provided a method for reducing unburned methane in a gas stream resulting from methane combustion, such as for example a gas stream from a natural gas engine, a natural gas vehicle (NGV) or a natural gas power plant, or any other process where unwanted methane release or slip may occur, the gas stream comprising sulfur, the method comprising passing the gas stream through a methane oxidation catalyst having a support comprising alumina doped with lanthanum and comprising platinum and palladium as active phases, thereby producing an exhaust stream having reduced levels of methane relative to the gas stream resulting from methane combustion, wherein the platinum and palladium are present in the methane oxidation catalyst at a weight ratio of Pt:Pd that is equal to or alternatively greater than 0.2:1.0, and equal to or alternatively less than 0.75:1.0.

According to a further exemplary embodiment, there is provided use of a methane oxidation catalyst for reducing unburned methane from a gas stream resulting from methane combustion, for example a gas stream from a natural gas engine, a natural gas vehicle (NGV) or natural gas power plant, or any other process where methane release may occur, the gas stream comprising at least sulfur, the methane oxidation catalyst having a support comprising alumina doped with lanthanum and comprising platinum and palladium as active phases, wherein the platinum and palladium are present in the methane oxidation catalyst at a weight ratio of Pt:Pd that is equal to or alternatively greater than 0.2:1.0, and equal to or alternatively less than 0.75:1.0.

According to any one of the foregoing embodiments, the gas stream resulting from the methane combustion may have a temperature of between 350° C. and 600° C.

According to any one of the foregoing embodiments, the gas stream resulting from methane combustion comprises between 10 and 20,000 ppm of methane. In another embodiment, the gas stream resulting from methane combustion comprises oxygen. Yet further, the gas stream of any one of the foregoing embodiments resulting from methane combustion comprises water.

According to another exemplary embodiment, there is provided a methane oxidation catalyst for use in a catalytic converter that is mountable on a natural gas engine, a natural gas vehicle (NGV), natural gas power plant, or any other apparatus where methane slip or release may occur, the methane oxidation catalyst having a support comprising alumina doped with lanthanum and comprising platinum and palladium as active phases, and are present at an amount effective for producing an exhaust stream from the vehicle having reduced levels of methane in the presence of sulfur relative to a gas stream resulting from combustion, wherein the platinum and palladium are present in the methane oxidation catalyst at a weight ratio of Pt:Pd that is equal to or alternatively greater than 0.2:1.0, and equal to or alternatively less than 0.75:1.0.

According to any one of the foregoing embodiments, the catalyst may contain platinum at an amount between 0.5 and 20 wt % and/or the palladium at an amount between 0.5 and 20 wt %. In another embodiment, the platinum is present in the amounts between 3 and 5 wt % and the palladium is present at an amount between 1 and 3 wt %. Yet further, the palladium may be present in the catalyst at greater than 2 wt %.

According to any one of the foregoing embodiments, the catalyst may have a T₅₀ of below 500° C. after aging in a simulated natural gas vehicle (NGV) exhaust for 500 h at 500° C. in the presence of 10 vol % water and 10 ppm sulfur dioxide.

According to any one of the foregoing embodiments, the methane oxidation catalyst is prepared by incipient wetness impregnation in which the platinum and palladium are added sequentially, or the methane oxidation catalyst is prepared by wet impregnation in which the platinum and palladium are added simultaneously.

According to any one of the foregoing embodiments, the alumina is gamma alumina. In yet a further embodiment, the specific surface area (BET) of the lanthanum doped support is at least 120 m²/g.

### BRIEF DESCRIPTION OF THE DRAWING

FIG. 1—illustrates temperatures of 50% methane conversion (T₅₀) over different catalysts as a function of the total noble metal loading, with catalyst Pt:Pd weight ratios ranging from 2.5:1.0 to 0.21:1.0.

FIG. 2—illustrates methane oxidation performance of the PdPt(5:2) and the PdPt(2:4) reference catalysts during 40h at 500° C. under simulated lean-burn natural gas engine exhaust (1000 ppm CH₄, 10 vol % O₂, 10 vol % H₂O, 6 vol % CO2, balance N₂, SV: 0.06 g s/cm³).

FIG. 3—provides a comparison of CH₄ conversion over the fresh and aged PdPt(5:2) catalyst in comparison with the aged PdPt(2:4) reference catalyst. Testing conditions: 1000 ppm CH₄, 10 vol % O₂, 10 vol % H₂O, 6 vol % CO₂, balance N₂, SV: 0.06 g s/cm³. Temperature ramp: 150 to 600 ° C. at 3 ° C./min.

### DETAILED DESCRIPTION OF SELECTED EMBODIMENTS

Embodiments disclosed herein are directed to methane oxidation catalysts comprising a support comprising alumina doped with lanthanum, and further comprising platinum and palladium as active phases. In further embodiments the catalysts consist of platinum and palladium as the active phases, other than minor impurities (e.g. less than 1% by weight). In further embodiments the catalysts consist of platinum and palladium as the active phases. Such catalysts, at least in selected embodiments, may be caused to act upon methane in a gas or gas mixture from any source (the “source gas”), including but not limited to methane or natural gas derived from landfill sites, sewer lines, septic tanks and septic tank pumper trucks, agricultural manures, natural gas production, oil and bitumen processing and storage, oil production, wood pellets storage, renewable natural gas production and use (e.g. biogas). In doing so, the resulting gas or gas mixture after catalysis (the “product gas”) comprises a lower quantity (e.g. by weight) of methane. In selected embodiments, the source gas has a temperature, or is heated to a temperature, of from 350° C. and 600° C. for catalysis. The simplicity of the active phase component metal combination of platinum and palladium, absent other active phase metals other than possible impurities, has yielded surprisingly beneficial results in terms of catalyst use and stability.

In some embodiments, the source gas comprises a gas stream resulting from methane combustion in any methane combustion process or apparatus, including but not limited to a natural gas engine (e.g. a lean-burn engine), such as the engine of a natural gas vehicle (NGV), or a natural gas power plant. Often, in such embodiments, the source gas has a temperature from 350° C. and 600° C. resulting from the combustion process without need to heat the source gas prior to catalysis. Unburned methane remaining after combustion is converted to carbon dioxide and water. As a result, the exhaust stream from the engine, at least in some embodiments, will have reduced levels of methane, which is a potent greenhouse gas. Certain exemplary embodiments may provide a methane oxidation catalyst for use in a natural gas engine (e.g. for use in a natural gas vehicle (NGV)) or natural gas power plant with enhanced resistance to deactivation in the presence of gaseous water and sulfur and/or that display enhanced thermal stability.

The inventors, through significant ingenuity, have successfully developed methane oxidation catalysts, corresponding methods and uses, with Pt:Pd weight ratios that have not previously been shown to provide useful catalysts. Such results were unexpected based upon prior knowledge in the art, and can be applied to any source of methane or natural gas, or related off-gas, to reduce the methane content thereof.

By the term “vehicle” as used herein, it is meant any machine or device used as a transportation means over land, sea or space. The vehicle may be a compressed natural gas (CNG) or liquid natural gas (LNG) vehicle. The vehicle may be powered by a lean burn engine. In such an engine, excess air is introduced to the combustion chamber. However, any reference herein to a natural gas vehicle may be substituted for natural gas engine or natural gas power plant depending upon the application for the discussed embodiment.

By the term “doped” with reference to the presence of lanthanum in the alumina support, it is meant that the methane oxidation catalyst contains lanthanum (La) in the alumina matrix. Without being limiting, lanthanum may also be present at least on the surface of the alumina, or a combination thereof.

In one embodiment, the support doped with lanthanum is a metal oxide such as alumina. Alumina, also known as aluminium oxide, is a chemical compound of aluminium and oxygen with the chemical formula Al₂O₃. An example of an alumina support doped with lanthanum that may be used to prepare the catalyst is Puralox® Scfa 140L3. The catalyst may also comprise a mixture of different support materials. The alumina may be gamma alumina. In another embodiment, the specific surface area (BET) of the support is at least 120 m²/g, at least 130 m²/g or at least 140 m²/g.

The platinum and palladium are each present in the catalyst at an amount effective for producing a product gas resulting from the catalysis, such as an exhaust stream from the natural gas engine or power plant, having reduced levels of methane in the presence of sulfur relative to a source gas, such as a gas stream resulting from combustion. The concentration of the metals may be effective to reduce the methane content in the gas stream resulting from methane combustion by at least 65%, or by at least 75%, at 500° C. after 500 hours on stream. Examples of ranges of effective amounts of each active metal are set forth below. The precise amounts of platinum and palladium for obtaining enhanced methane conversion can be determined by the methodology set forth in the examples.

In selected embodiments, for example, the platinum and palladium may be present in the catalyst at a weight ratio of of Pt:Pd of at least 0.2:1.0, or at least 0.2001:1.0, or at least 0.201:1.0, or at least 0.21:1.0, or at least 0.3:1.0, or at least 0.4:1.0, or at least 0.5:1.0, or at least 0.6:1.0, or at least 0.7:1.0. In any such embodiments the upper limit of the range for Pt:Pd may be not more than 0.3:1.0, 0.4:1.0, 0.5:1.0, 0.6:1.0, 0.7:1.0, 0.749:1.0, 0.7499:1.0 or 0.75:1, and any of these upper limits can be combined with any of the above-mentioned lower limits. Certain embodiments also include a range of such Pt:Pd weight ratios. In other embodiments, the range of weight ratios of Pt:Pd can be 0.20:1 to 0.75:1, 0.2001:1 to 0.7499:1, 0.201 to 0.749, 0.2001:1.0 to 0.7499:1.0, or 0.3:1 to 0.6:1.0. Unexpectedly, weight ratios of Pt:Pd of less than 0.75:1.0, and yet more than 0.2:1.0, preferably 0.2001 to 0.7499, or from 0.201:1 to 0.749:1.0, or from 0.21 to 0.74, provide essentially equivalent or advantageous results for such methane oxidation catalysts.

In one embodiment, the platinum is present in the catalyst at a concentration of between 0.5 wt % and 20 wt %, between 0.5 wt % and 10 wt %, or between 1 wt % and 8 wt %, or between 1.5 wt % and 6 wt %, or between 2.0 wt % and 5.5 wt %, or between 2.5 wt % and 5 wt % or between 3.0 wt % and 4.5 wt %.

In a further embodiment, the palladium is present in the catalyst at a concentration of between 0.5 wt % and 20 wt %, between 0.5 wt % and 10 wt %, or between 0.5 wt % and 6 wt %, or between 0.5 wt % and 4 wt %, or between 0.5 and 3 wt %, or between 0.75 wt % and 3.5 wt % or between 1 wt % and 3 wt %.

In a further embodiment, palladium is present in the methane oxidation catalyst at a concentration of between 2 wt % and 10 wt %, or between 2 wt % and 6 wt %, or between 2 wt % and 4 wt %.

In one embodiment, the methane oxidation catalyst has a T₅₀ of below 500° C. after aging in a simulated natural gas vehicle exhaust. As would be known to those of skill in the art, T₅₀ is the temperature at which half the methane in a gas stream is combusted to carbon dioxide and water. The T₅₀ is measured as described in Example 1. Methane conversion was determined using a bench scale reactor. The temperature at 50% methane conversion was determined after aging at 500° C. for 500 h in the presence of 1,000 ppm CH₄, 10% O₂, 6% CO₂, 10% H₂O vapour and 10 ppm SO2. The reactant gas hourly space velocity (GHSV) was ˜55,000 h⁻¹. The temperature ramp was from 150 to 600° C. at 3° C./min.

The catalyst may be prepared by any method known to those of skill in the art. A non-limiting example of a suitable method is incipient wetness impregnation (IWI). According to this method, the active metal precursor is dissolved in an aqueous or organic solution. Then the metal-containing solution is added to a catalyst support and capillary action draws the solution into the pores. The catalyst can subsequently be dried and calcined to drive off the volatile components within the solution, depositing the metal on the catalyst surface. The concentration profile of the impregnated compound depends on the mass transfer conditions within the pores during impregnation and drying.

Catalysts may also be prepared by the wet impregnation (WI) method. According to this method, the support powder is suspended in an excess of a solution containing one or more precursors and stirred for some time in order to fill the pores with the precursor solution. The pH of the impregnating solution can be adjusted to a basic pH, for example using a concentrated solution of ammonia, to provide electrostatic interaction between cationic metal species and negatively charged surface hydroxyls of the support. The catalyst is subsequently dried followed by calcination in air.

As noted, the catalyst can be prepared by any suitable method. However, the method of preparing the catalyst can impact the properties of the catalyst and can lead to improvements in the T₅₀ value. Thus, the method for preparation can be selected to achieve a desired T₅₀ value. In one non-limiting example, the catalyst is prepared by IWI and the metals are added sequentially. In such embodiment, the catalyst is dried and calcined between additions of metal. In yet a further embodiment, the catalyst is prepared by the IWI method and the platinum is added before palladium. In another embodiment, the catalyst is prepared by WI and the metals are added simultaneously. Simultaneous addition includes dissolving the metals together and subsequently adding them to the support, followed by drying and calcination. Employing either of these methods can result in a catalyst exhibiting a T₅₀ value that is below about 460° C. (see Table 6 below).

The methane oxidation catalyst may be used, for example, in the manufacture of a catalytic converter that is mounted on the exhaust system of a natural gas vehicle.

The catalytic converter may be produced by known methods. Without being limiting, the catalytic converter may be a two-way catalytic converter.

When the methane oxidation catalyst is in use, a gas stream resulting from natural gas combustion in a combustion chamber in the vehicle passes through the methane oxidation catalyst of the catalytic converter, thereby reducing its methane content. As a result, reduced concentrations of methane are emitted to the atmosphere from the exhaust, such as the tail pipe of a natural gas powered car or truck. The gas stream resulting from methane combustion in the natural gas engine will typically comprise at least sulfur and water. Other components that may be present in the gas stream may include oxygen and carbon dioxide.

The methane content in the gas stream resulting from methane combustion may contain between 10 and 20,000 ppm or methane, between 100 and 10,000 ppm of methane, or between 200 and 5,000 ppm of methane.

The sulfur content in the gas stream resulting from methane combustion may be between 1 ppm and 30 ppm sulfur, or between 3 ppm and 30 ppm sulfur or between 5 ppm and 30 ppm sulfur or between 6 ppm and 30 ppm sulfur.

The gas stream resulting from methane combustion may have a temperature of between 350° C. and 600° C. or between 400° C. and 600° C. In situation where the catalysts are employed for gas sources or gas streams having lower temperatures, in may be necessary in some embodiments to heat the gas source or gas stream to a higher temperature closer to 350° C. or between 350° C. and 600° C. for more efficient catalysis.

### EXAMPLES

The following example provide details of selected exemplary embodiments and are not limiting with respect to the appended claims.

Table 1 below summarizes the composition of the methane oxidation catalysts used in selected experiments and the notation used to refer to each catalyst composition throughout the example section. The notations employed herein include a designation assigned to each catalyst preparation representing the metals present in the catalyst (“PdPt” or “Pd”), followed by the nominal loading of the metal or metals represented by a fraction (wt:wt) of the two metals. As indicated in Table 1, the balance of the catalyst in each case contains a lanthanum doped alumina support that is commercially available under the trade-name, Puralox® Scfa140L3.

TABLE 1
Composition of catalysts and their notation used herein

| | Catalyst designation/nominal loading (wt %) | | | | | |
|---|---|---|---|---|---|---|
| Component | PdPt(1:2) | PdPt(2:2) | PdPt(2:4) | PdPt(4:2) | Pd(0.5) | PdPt(5:2) |
| Pd (wt %) | 1 | 2 | 2 | 4 | 0.5 | 5 |
| Pt (wt %) | 2 | 2 | 4 | 2 | 0 | 2 |
| Puralox ® | Balance | Balance | Balance | Balance | Balance | Balance |
| Scfa140L3 | | | | | | |

### Example 1: Catalysts with Pd and Pt on a Lanthanum Doped Alumina Exhibit Enhanced Methane Conversion After Aging in the Presence of Sulfur and Water

Two catalysts comprising platinum (Pt) and palladium (Pd) were prepared by incipient wetness impregnation (IWI). The first was prepared using 4 wt % Pt and 2 wt % Pd and the second with 2 wt % Pt and 4 wt % Pd on a lanthanum doped alumina support (Puralox® Scfa 140L3). For both catalysts, the palladium was added last in the impregnation sequence. Methane conversion was determined using a bench scale reactor. The temperatures at 50% methane conversion (T₅₀) were determined for fresh and aged catalysts by running the sample in a temperature range from 150 to 600° C. (3° /min) in the presence of 1,000 ppm CH₄, 10% O₂, 6% CO₂, 10% H₂O vapour and 10 ppm SO₂ and at a reactant gas hourly space velocity (GHSV) of ˜55,000 h⁻¹. Aging was performed at 500° C. in the presence of 1,000 ppm CH₄, 10% O₂, 6% CO₂, 10% H₂O vapour and 10 ppm SO₂ with a reactant gas hourly space velocity (GHSV) of ˜55,000 h⁻¹. The time periods for aging were 40, 100, 200, 300 and 500 hours.

The results are shown in Table 2 below.

TABLE 2
T₅₀ values of PdPt(2:4) and PdPt(4:2)
catalysts after aging at 500° C.

Aging time (h)/T₅₀ (° C.)

| Catalyst | 0 | 40 | 100 | 200 | 300 | 500 |
|---|---|---|---|---|---|---|
| PdPt(2:4) | 362 | 449 | 456 | 460 | 450 | 454 |
| PdPt(4:2) | 356 | 452 | 458 | 461 | 463 | 466 |

The presence of both metals in a catalyst comprising a lanthanum doped alumina support enhanced the methane oxidation performance of the catalyst. The results in Table 2 show a T₅₀ of near 450° C. for PdPt(2:4) after aging at 300 and 500 hours at 500° C. in the presence of both sulfur and water vapour (T₅₀ of 450 and 454 at 300 and 500 hours, respectively). The PdPt(4:2) catalyst exhibits a T₅₀ of near 460° C. after the same aging duration (T₅₀ values of 463° C. and 466° C. at 300 and 500 hours, respectively). These results thus show that both catalysts displayed excellent chemical and hydrothermal stability in the presence of sulfur and water. Nevertheless the PdPt(2:4) catalyst displayed better performance (T₅₀ of 454° C.) than the PdPt(4:2) catalyst (T₅₀ of 466° C.) after the longest aging time (500 hours). This indicates that a higher Pt to Pd ratio achieves increased long-term hydrothermal stability and sulfur resistance.

### Example 2: A Catalyst with a Lanthanum Doped Alumina Support Exhibits Higher Activity in the Presence of Excess Water Vapour than a Catalyst with an Alumina Support not Doped with Lanthanum

The activity in the presence of excess water for catalysts prepared when using a lanthanum doped alumina support and an alumina support not doped with lanthanum was also examined. Pd-based catalysts were prepared by using either γ-alumina (0.5% Pd/Al₂O₃), a support that was not doped with lanthanum, or Puralox® Scfa 140L3 (0.5% Pd/Puralox®) that was doped with lanthanum. Each catalyst was tested using a gas composition of 1,000ppm CH₄, 10% O₂, 6% CO₂ and 10% H₂O vapor (wt %) and the reactant gas hourly space velocity (GHSV) in the range of 44000-55,000 h⁻¹. The results are shown in Table 3 below.

TABLE 3
T₅₀ of 0.5 wt % Pd/Al₂O₃ and 0.5 wt % Pd/Puralox ® Scfa
140L3 in the presence of excess water vapour (10 vol %)

| Catalyst | T₅₀ (° C.) |
|---|---|
| 0.5 wt % Pd/Al₂O₃ - no lanthanum | 440 |
| 0.5 wt %/Puralox - with lanthanum | 392 |

The results in Table 3 show that the T₅₀ of 0.5 wt %/Puralox is significantly lower (indicating higher activity) than that of a 0.5 wt % Pd/Al₂O₃ catalyst, which contains no lanthanum. Thus, an activity improvement using an alumina support doped with lanthanum was realized.

### Example 3: Sulfur Resistance and Hydrothermal Stability of Catalysts having an Alumina Support Doped with Lanthanum at Different Weight Ratios of Platinum and Palladium

The sulfur resistance of methane oxidation catalysts having an alumina support doped with lanthanum at different weight percents of platinum and palladium was examined. Catalysts PdPt(1:2) and PdPt(2:4) were prepared by using Puralox® Scfa 140L3, which is doped with lanthanum. Each catalyst was then aged for 40 hrs at 500° C. in the presence of sulfur and water. Specifically, the gas composition was 1000 ppm CH4, 10% O₂, 6% CO₂, 10% H₂O vapour and 10 ppm SO₂ and the reactant gas hourly space velocity (GHSV) was ˜55,000 h⁻¹. The temperature ramp for the T₅₀ evaluation was from 150 to 600° C. at 3° /min. The results are shown in Table 4 below.

TABLE 4
T₅₀ of catalysts prepared with various amounts
of Pt and Pd on Puralox ® Scfa140L3
in the presence of water and sulfur.

| | T₅₀ (° C.) |
|---|---|
| Catalyst | Aged (40 h) |
| PdPt(1:2) | 481 |
| PdPt(2:4) | 449 |

The sulfur resistance and hydrothermal stability of the catalyst was significantly increased by using the combination of Pt and Pd on the Puralox® support and more specifically by using 2 wt % of Pd and 4 wt % of Pt, which corresponds to a weight ratio of Pt:Pd of 2:1. The T₅₀ of PdPt(2:4) (after 40 h of aging) is 32° C. lower than the T₅₀ obtained by PdPt(1:2), demonstrating the increased sulfur and water tolerance of PdPt(2:4).

### Example 4: Effect of Calcination Temperature on Catalyst Activity

Table 5 shows the T₅₀ obtained after catalyst aging for 40 hours as a function of catalyst calcination temperature. The aging was performed at 500° C. using a gas stream having the following components: 1000 ppm CH₄, 10% O₂, 10% H₂O, 6% CO₂, 10 ppm SO₂, with the balance being N₂. The T₅₀ was determined using the same simulated exhaust gas composition as the experiments conducted in Example 1. After 40 hours of aging the T₅₀ of the catalyst calcined at 500° C. is similar to that of the catalyst calcined at 550° C. The results indicate that the catalyst activity is slightly better at the lower calcination temperature. Based on these findings, a calcination temperature of 500° C. can be used for catalyst preparation to lower energy consumption and catalyst costs. In light of these results, all further catalysts were prepared using a calcination temperature of 500° C.

TABLE 5
T₅₀ of catalysts prepared using different calcination temperatures

| | Calcination temperature | T₅₀ (° C.) |
|---|---|---|
| Catalyst name | (° C.) | Aged (40 h) |
| PdPt(2:4) | 550 | 450 |
| | 500 | 446 |

### Example 5: Effect of Method Preparation on Catalyst Activity

The methane oxidation catalysts shown in Table 6 below were prepared using one of two methods: incipient wetness impregnation (IWI) or wet impregnation (WI). For both methods, the precursors were added either sequentially or simultaneously to the support. When added simultaneously, the precursors were dissolved together and then added to the support followed by drying and calcination. If the sequential addition method was used, then the catalyst was dried and calcined between the additions of the metals. All sequential impregnations had the platinum precursor added first, followed by the addition of palladium precursor. All catalysts used a commercial lanthanum-doped y-alumina, Puralox® SCFa-140 L3 (Puralox), as the support. Pd(NO₃)₂⋅xH₂O and Pt(NH₃)₄(NO₃)₂ were used for the palladium and platinum precursors, respectively.

TABLE 6
T₅₀ of catalysts prepared by different preparation methods.

| | | T₅₀ (° C.) |
|---|---|---|
| Catalyst name | Preparation method | Aged (40 h) |
| PdPt(2:4) | IWI Sequential | 446 |
| | IWI Simultaneous | 466 |
| | WI Sequential | 517 |
| | WI Simultaneous | 449 |

15

The results show that the method of preparation and the order of adding the precursor can have an impact on catalyst activity. The catalyst prepared using the IWI preparation method and adding the precursors sequentially (Pt followed by Pd) shows a lower T₅₀ than the catalyst prepared with the same method with the precursors added simultaneously (446° C. and 466° C., respectively). The result demonstrates that the IWI sequential addition can provide a better performing catalyst than that prepared by simultaneous IWI impregnation.

On the other hand the catalyst prepared by WI shows the opposite effect. The catalyst prepared using the sequential addition (T₅₀ of 517° C.) is less active than the catalyst prepared by adding the precursors simultaneously (T₅₀ of 449° C.).

### Example 6: Methane Oxidation Catalysts Composed of a Pt:Pd Mass Ration of Less than 0.75:1.0

Previous examples describe a methane oxidation catalyst that is composed of palladium, platinum supported on a commercial support of lanthanum doped alumina. Previous examples specify catalysts with a Pt:Pd mass ratio equal to or greater than 0.75:1.

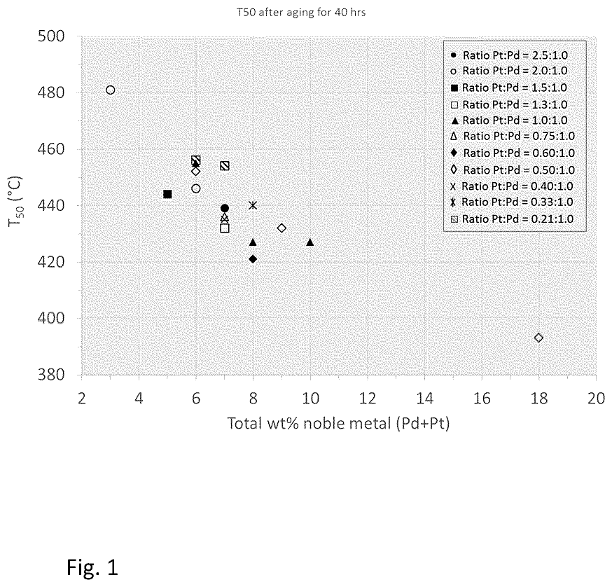

To test alternative ranges for the Pt:Pd mass ratio, catalysts were prepared with Pt:Pd mass ratio between 0.20 and 2.50 with a total noble metal wt % content between 3.0 to 18.0 wt %. Each catalyst was aged using the same procedure as described, for comparison of activity and stability. The procedure was as follows: evaluation of the fresh catalysts T₅₀ with a gradient run that included exposing 500 mg of catalyst to a simulated natural gas (NG) engine exhaust from 150° to 600° C. at 3° C./minute. This was followed by aging for 40 hrs at 500° C. in the same NG simulated exhaust. A final gradient run was performed, identical to the first one described above, to determine the catalyst T₅₀ after aging. The gas composition was 1000 ppm CH₄, 10 vol % O₂, 6 vol % CO₂, 10 vol % H₂O vapour and 10 ppm SO2 and the reactant gas hourly space velocity (GHSV) was approximately 55,000 h⁻¹. The T₅₀s, from highest to lowest, after the 40 h aging run are shown in Tables 7a, and were plotted as a function of total noble metal weight % (see FIG. 1).

Table 7b provides the same information as Table 7a but with the data sorted by descending order of Pt:Pd ratio instead of by descending order of T₅₀.

TABLE 7a
Methane oxidation catalyst Pd:Pt mass ratio, total noble metal wt %
and T₅₀, sorted by descending order of T₅₀ (from highest to lowest)

| Pt:Pd mass | Total wt % | T₅₀ after aging |
|---|---|---|
| ratio | noble metal | for 40 hrs |
| 2 | 3 | 481 |
| 0.21 | 6 | 456 |
| 1 | 6 | 455 |
| 0.21 | 7 | 454 |
| 0.5 | 6 | 452 |
| 2 | 6 | 446 |
| 1.5 | 5 | 444 |
| 0.33 | 8 | 440 |
| 2.5 | 7 | 439 |
| 0.75 | 7 | 436 |
| 0.4 | 7 | 435 |
| 1.33 | 7 | 432 |
| 0.5 | 9 | 432 |
| 1 | 8 | 428 |
| 1 | 10 | 428 |
| 0.6 | 8 | 421 |
| 0.5 | 18 | 394 |

TABLE 7b
Methane oxidation catalyst Pd:Pt mass ratio, total noble metal
wt % and T₅₀, sorted by descending order of Pt:Pd ratio

| Pt:Pd mass | Total wt % | T₅₀ after aging |
|---|---|---|
| ratio | noble metal | for 40 hrs |
| 0.21 | 6 | 456 |
| 0.21 | 7 | 454 |
| 0.33 | 8 | 440 |
| 0.40 | 7 | 435 |
| 0.50 | 6 | 452 |
| 0.50 | 9 | 432 |
| 0.50 | 18 | 394 |
| 0.60 | 8 | 421 |
| 0.75 | 7 | 436 |
| 1.00 | 6 | 455 |
| 1.00 | 8 | 428 |
| 1.00 | 10 | 428 |
| 1.33 | 7 | 432 |
| 1.50 | 5 | 444 |
| 2.00 | 3 | 481 |
| 2.00 | 6 | 446 |
| 2.50 | 7 | 439 |

The chart of FIG. 1 shows that the T₅₀ decreases with increasing total metal content. A lower T₅₀ indicates a catalyst with increased methane oxidation activity. Thus, the data indicates that the total noble metal content is an important factor for catalyst activity.

For selected Pt:Pd mass ratios, more than one data point is shown in FIG. 1 for each mass ratio using the same symbol for different experiments according to the different total wt % of noble metals present.

All of the catalysts tested exhibit a T₅₀ below 500° C. A catalyst with a T₅₀ below 500° C. after 40h of aging is generally considered a suitable candidate to be used for methane oxidation in the typical temperature range of natural gas engine exhaust.

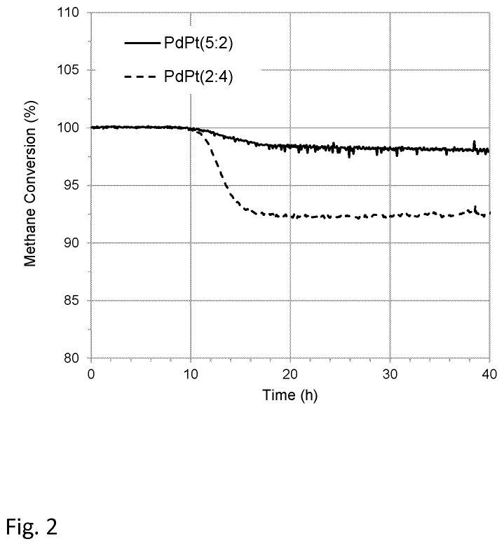

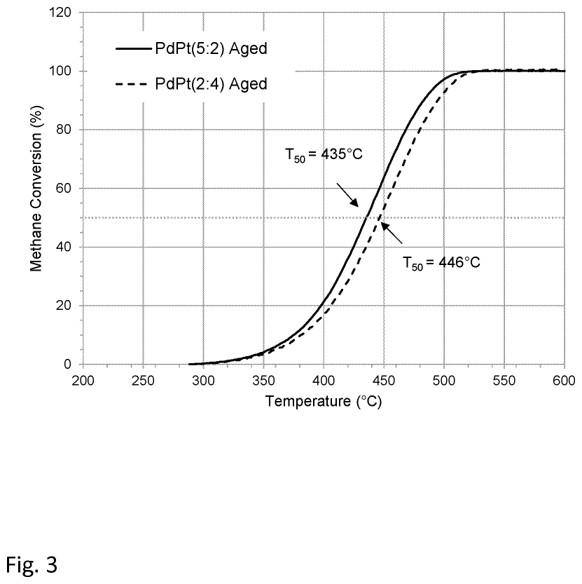

FIG. 2 illustrates data to show methane oxidation performance of the PdPt(5:2) and the PdPt(2:4) reference catalysts during 40h at 500° C. under simulated lean-burn natural gas engine exhaust (1000 ppm CH₄, 10 vol % O₂, 10 vol % H₂O, 6 vol % CO₂, balance N₂, SV: 0.06 g s/cm³). Further, FIG. 3 provides a comparison of CH₄ conversion over the fresh and aged PdPt(5:2) catalyst in comparison with the aged PdPt(2:4) reference catalyst. Testing conditions: 1000 ppm CH₄, 10 vol % O₂, 10 vol % H₂O, 6 vol % CO₂, balance N₂, SV: 0.06 g s/cm³.

Therefore, FIG. 2 shows the comparison of the performance of the PdPt(5:2) catalyst and the reference PdPt(2:4) catalyst during long-term aging at 500° C. for 40 h in the NG engine simulated exhaust stream. Both catalysts show identical conversion for the initial phase of aging. However, surprisingly, after 10 h, the methane conversion of the reference decreases to 93% meanwhile the PdPt(5:2) catalyst exhibited better conversion of 98% even after the full 40 h of aging. This result is unexpected as the data obtained in Table 2 indicates that when the content of Pt is lower than Pd, the catalyst stability and activity is worse. Furthermore, FIG. 3 demonstrates the CH₄ conversion versus temperature curves of both catalysts after the 40 h aging procedure. The T₅₀ of the PdPt(5:2) catalyst is lower by 11° C. than that of the PdPt(2:4) reference catalyst thus confirming the former catalyst is more active and stable after aging.

Taken together, these data provide clear evidence that corresponding methane oxidation catalysts comprising active metal phases with Pd:Pt ratios of less than 0.75:1.0 present viable options for industrial use.

Accordingly, selected embodiments include methods for reducing unburned methane in any gas source or gas stream (such as but not limited to those resulting from methane combustion for example in a natural gas engine (e.g. a lean-burn engine) and/or a natural gas power plant) the gas source or stream comprising sulfur, the method comprising contacting the source gas or gas stream with a methane oxidation catalyst having a support comprising alumina doped with lanthanum and comprising platinum and palladium as active phases, thereby producing a product gas or gas stream having reduced levels of methane relative to the source gas or gas stream, wherein the platinum and palladium are present in the methane oxidation catalyst at a weight ratio of Pt:Pd that is between 0.2:1.0 and 0.75:1.0, or alternatively from 0.2001:1 and 0.7499:1.0, or alternatively from 0.201:1.0 to 0.749:1.0, or alternatively from 0.21:1.0 to 0.74:1.0. In some such embodiments the lower limit of the weight ratio of Pt:Pd of the catalyst may be selected from 0.2001:1.0, 0.201:1.0, 0.21:1.0, 0.3:1.0, 0.4:1.0, 0.5:1.0, and 0.6:1.0. In further embodiments, the upper limit of the weight ratio of Pt:Pd of the catalyst may be selected from 0.3:1.0, 0.4:1.0, 0.5:1.0, 0.6:1.0, 0.7:1.0, 0.74:1.0, 0.749:1.0 and 0.7499:1.0. Preferably, the catalyst consists of platinum and palladium as active metal phases other than minor impurities. More preferably, the catalyst consists of platinum and palladium as active metal phases.

Further embodiments encompass a methane oxidation catalyst for reducing unburned methane in any source gas or gas stream (including but not limited to those resulting from methane combustion in a natural gas engine or natural gas power plant), the gas source or gas stream comprising sulfur, the methane oxidation catalyst having a support comprising alumina doped with lanthanum and comprising platinum and palladium as active phases, wherein the platinum and palladium are present in the methane oxidation catalyst at a weight ratio of Pt:Pd in the catalyst that is between 0.2:1.0 and 0.75:1.0, or alternatively from 0.2001:1 to 0.7499:1.0, or alternatively from 0.201:1.0 to 0.749:1.0, or alternatively from 0.21:1.0 to 0.74:1.0. In some such embodiments the lower limit of the weight ratio of Pt:Pd in the catalyst may be selected from 0.2001:1.0, 0.201:1.0, 0.21:1.0, 0.3:1.0, 0.4:1.0, 0.5:1.0, and 0.6:1.0. Furthermore, in any such embodiments the upper limit of the weight ratio of Pt:Pd may be selected from 0.3:1.0, 0.4:1.0, 0.5:1.0, 0.6:1.0, 0.7:1.0, 0.74:1.0, 0.749:1.0 and 0.7499:1.0. Preferably, the catalyst consists of platinum and palladium as active metal phases other than minor impurities. More preferably, the catalyst consists of platinum and palladium as active metal phases.

Further selected embodiments provide a methane oxidation catalyst having a support comprising alumina doped with lanthanum and comprising platinum and palladium as active phases, present at an amount effective for producing a product gas post-catalysis having reduced levels of methane relative to the source gas, wherein the platinum and palladium are present in the methane oxidation catalyst at a weight ratio of Pt:Pd that is between 0.2:1.0 and 0.75:1.0, or alternatively from 0.2001:1.0 to 0.7499:1.0, or alternatively from 0.201:1.0 to 0.749:1.00, or alternatively from 0.21:1.0 to 0.74:1.0. In some such embodiments of the methane oxidation catalysts the lower limit of the weight ratio of Pt:Pd in the catalyst may be selected from 0.2001:1.0, 0.201:1.0, 0.21:1.0, 0.3:1.0, 0.4:1.0, 0.5:1.0, and 0.6:1.0.In further embodiments the upper limit of the weight ratio of Pt:Pd in the catalyst may be selected from 0.3:1.0, 0.4:1.0, 0.5:1.0, 0.6:1.0, 0.7:1.0, 0.74:1.0, 0.749:1.0 and 0.7499:1.0. Preferably, the catalyst consists of platinum and palladium as active metal phases other than minor impurities. More preferably, the catalyst consists of platinum and palladium as active metal phases.

Selected embodiments have been described with regard to one or more embodiments or examples. It will be apparent to those of skill in the art that other variations and modifications can be made without departing from the scope of the invention as defined in the claims.

1. A method for reducing methane in a source gas comprising methane and sulfur, the method comprising contacting the source gas with a methane oxidation catalyst having a support comprising alumina doped with lanthanum and comprising platinum and palladium as active phases, to produce a product gas comprising reduced levels of methane compared to the source gas,
wherein the platinum and palladium are present in the methane oxidation catalyst at a weight ratio of Pt:Pd that is between 0.2:1.0 and 0.75:1.0.

2. The method of claim 1, wherein the methane oxidation catalyst consists of platinum and palladium as active phases, optionally together with less than 1% by weight of active phase impurities.

3. The method of claim 1 or 2, wherein the lower limit of the weight ratio of Pt:Pd is selected from 0.2001:1.0, 0.201:1.0, 0.21:1.0, 0.3:1.0, 0.4:1.0, 0.5:1.0, 0.6:1.0 and 0.7:1.0.

4. The method of claim 1, 2, or 3, wherein the upper limit of the weight ratio of Pt:Pd is selected from 0.3:1.0, 0.4:1.0, 0.5:1.0, 0.6:1.0, 0.7:1.0, 0.74:1.0, 0.749:1.0, and 0.7499:1.0.

5. The method of claim 1, wherein the source gas results from methane combustion and has a temperature of between 350° C. and 600° C.

6. The method of claim 1, wherein the source gas is heated to a temperature of between 350° C. and 600° C. prior to or upon contact with the methane oxidation catalyst.

7. The method of claim 1, wherein the platinum and/or palladium are each present in the methane oxidation catalyst at between 0.5 and 20 wt %.

8. The method of claim 1, wherein the platinum and palladium are present in the methane oxidation catalyst at a concentration effective to reduce the methane content in the source gas by at least 75% at 500° C. after 500 hours on stream.

9. The method of claim 1, wherein the methane oxidation catalyst has a T₅₀ of below 500° C. after aging in a simulated gas exhaust, such as a simulated natural gas vehicle exhaust, for 500 h at 500° C. in the presence of 10 vol % water and 10 ppm sulfur dioxide.

10. The method of claim 1, wherein the methane oxidation catalyst is prepared by incipient wetness impregnation in which the platinum and palladium are added sequentially and in which platinum is added before palladium, or wherein the methane oxidation catalyst is prepared by wet impregnation in which the platinum and palladium are added simultaneously.

11. The method of claim 1, wherein the alumina is gamma alumina.

12. The method of claim 1, wherein the specific surface area (BET) of the support is at least 120 m²/g.

13. The method of claim 1, wherein the source gas is derived from a natural gas engine, a natural gas power plant, an industrial process, a mining process, an underground source, a sewage source, an agricultural source, or a store of methane-producing material.

14. A methane oxidation catalyst comprising a support comprising alumina doped with lanthanum, and comprising platinum and palladium as active phases, wherein the platinum and palladium are present in the methane oxidation catalyst at a weight ratio of Pt:Pd that is between 0.2:1.0 and 0.75:1.0.

15. The methane oxidation catalyst of claim 14, wherein the methane oxidation catalyst consists of platinum and palladium as active phases, optionally together with less than 1% by weight of active phase impurities.

16. The methane oxidation catalyst of claim 14 or 15, wherein the lower limit of the weight ratio of Pt:Pd is selected from 0.2001:1.0, 0.201:1.0, 0.21:1.0, 0.3:1.0,

0. 4:1.0, 0.5:1.0, 0.6:1.0 and 0.7:1.0.

17. The methane oxidation catalyst of claim 14, 15 or 16, wherein the upper limit of the weight ratio of Pt:Pd is selected from 0.3:1.0, 0.4:1.0, 0.5:1.0, 0.6:1.0, 0.7:1.0, 0.74:1.0, 0.749:1.0 and 0.7499:1.0.

18. The methane oxidation catalyst of claim 14 which exhibits catalytic activity upon methane in a source gas at, or heated to, a temperature of between 350° C. and 600° C.

19. The methane oxidation catalyst of claim 14, wherein the platinum and/or palladium are each present in the methane oxidation catalyst at between 0.5 and 20 wt %.

20. The methane oxidation catalyst of claim 19, wherein the platinum is present in the methane oxidation catalyst at between 3 and 5 wt % and the palladium is present in the methane oxidation catalyst at between 1 and 3 wt %.

21. The methane oxidation catalyst of claim 14, wherein the catalyst has a T₅₀ of below 500° C. after aging in a simulated natural gas vehicle (NGV) exhaust for 500 h at 500° C. in the presence of 10 vol % water and 10 ppm sulfur dioxide.

22. The methane oxidation catalyst of claim 14, prepared by incipient wetness impregnation in which the platinum and palladium are added sequentially and in which platinum is added before palladium, or wherein the methane oxidation catalyst is prepared by wet impregnation in which the platinum and palladium are added simultaneously.

23. The methane oxidation catalyst of claim 14, wherein the alumina is gamma alumina.

24. The methane oxidation catalyst of claim 14, wherein the specific surface area (BET) of the support is at least 120 m²/g.

25. The methane oxidation catalyst of any one of claims 14 to 24, for use to reduce a methane content of a source gas.

26. The methane oxidation catalyst for use according to claim 25, wherein the source gas is derived from a natural gas engine, a natural gas power plant, an industrial process, a mining process, an underground source, a sewage source, an agricultural source, or a storage of methane-producing material.

27. Use of the methane oxidation catalyst of any one of claims 14 to 24, to reduce methane content of a source gas.

28. Use according to claim 27, wherein the source gas is derived from a natural gas engine, a natural gas power plant, an industrial process, a mining process, an underground source, a sewage source, an agricultural source, or a storage of methane-producing material.
